(19) United States
(12) Patent Application Publication
(10) Pub. No.: US 2002/0170662 A1
(43) Pub. Date: Nov. 21, 2002

(54) Twin-wall composite sheet

(76) Inventor: Dieter Schauf, Leichlingen (DE)

Correspondence Address: BAYER CORPORATION, PATENT DEPARTMENT, 100 BAYER ROAD, PITTSBURGH, PA, 15205, US

(21) Appl. No.: 10/145,323

(22) Filed: May 14, 2002

(30) Foreign Application Priority Data
May 18, 2001 (DE) 10124210.7

(51) Int. Cl. B29C 47/00

(52) U.S. Cl. 156/244.15; 156/244.12

(57) ABSTRACT

A twin-wall composite sheet (8) comprising (a) at least one inner thermoplastic polymer film (2), and (b) at least two external thermoplastic polymer films (4 and 5) is described. The inner film (2) is interposed between and connected to at least two of the outer films (4 and 5). The inner film has a three-dimensional structure comprising a plurality of at least one of elevations and depressions. The inner film has two main directions of extension, and the three-dimensional structure of the inner film has a substantially periodically recurring pattern in the two main directions of extension thereof. The inner film is fixedly connected to at least two of the outer films in a region of maximum height of elevations of the inner film and/or a region of the maximum depth of depressions of the inner film. The twin-walled composite sheet preferably has substantially the same flexural modulus in the two main directions of extension of the inner film. Optionally, the twin-wall composite sheet can be provided with an external profile selected, for example, from external corrugated profiles or external trapezoidal profiles in a subsequent process step. The present invention also relates to a method of preparing the twin-wall composite sheet.

### CROSS REFERENCE TO RELATED PATENT APPLICATION

The present patent application claims the right of priority under 35 U.S.C. §119 (a)-(d) of German Patent Application No. 101 24 210.7, filed May 18, 2001.

### FIELD OF THE INVENTION

The invention relates to twin-wall composite sheets, which preferably have the same flexural strength in both main directions of extension, and to a method for the production thereof. The present invention also relates to twin-wall composite sheets having an external (or macro) profile, e.g., a corrugated external profile.

### BACKGROUND OF THE INVENTION

Twin-wall and multi-wall sheets made of plastics material which can be produced predominantly from one material (and optionally with thin protective surface layers made of other materials) by the art-recognized profile extrusion method, are known. They exhibit anisotropic properties and are, for example, more rigid in the extrusion direction than transversely thereto. Materials can also be combined to a limited extent for targeted adjustment of mechanical properties in particular.

The state of the art involves the production of twin-wall sheets of varying thickness (e.g., predominantly 3 to 30 mm) in widths of typically up to 2.10 m, from a thermoplastic material, such as thermoplastic polycarbonate (PC), thermoplastic polypropylene (PP) and similar thermoplastic materials, by the art-recognized profile extrusion technique. Such known twin-walled sheets may also be prepared with thin protective outer layers made of different thermoplastic materials.

### SUMMARY OF THE INVENTION

The objects of the present invention relate to twin-wall composite sheets (or plates) which preferably have substantially the same flexural strength in the two main directions of extension and can consist of a plurality of materials, and to a method for their production thereof.

In accordance with the present invention, there is provided a twin-wall composite sheet comprising:

(a) at least one inner film of a thermoplastic polymer; and

(b) at least two outer films of a thermoplastic polymer, said inner film being interposed between and connected to at least two of said outer films,

wherein said inner film has a three-dimensional structure comprising a plurality of at least one of elevations and depressions, said inner film having two main directions of extension, the three-dimensional structure of said inner film has a substantially periodically recurring pattern in the two main directions of extension of said inner film, and said inner film is fixedly connected to at least two of said outer films in at least one of a region of maximum height of elevations of said inner film and a region of the maximum depth of depressions of said inner film.

In further accordance with the present invention, there is provided a method for producing the twin-wall composite sheet described above, which comprises:

(i) providing said inner film with said three dimensional structure comprising a plurality of at least one of elevations and depressions;

(ii) attaching fixedly at least two of said outer films to said inner film; and

(iii) optionally providing said twin-wall composite sheet with an external (or macro-) profile selected from one of corrugated external profiles and trapezoidal external profiles.

The features that characterize the present invention are pointed out with particularity in the claims, which are annexed to and form a part of this disclosure. These and other features of the invention, its operating advantages and the specific objects obtained by its use will be more fully understood from the following detailed description and the accompanying drawings in which preferred embodiments of the invention are illustrated and described.

Other than in the examples, or where otherwise indicated, all numbers or expressions, such a those expressing structural dimensions, etc, used in the specification and claims are to be under stood as modified in all instances by the term “about.”

### BRIEF DESCRIPTION OF THE DRAWINGS

FIG. 1 is a schematic representation of a process by which twin-wall composite sheets according to the present invention may be formed;

FIG. 2 is a top-down view of a three dimensionally regularly shaped inner film of the twin-walled composite sheet of the present invention;

FIG. 2a is a sectional representation through line A-A of FIG. 2;

FIG. 2b is a sectional representation through line B-B of FIG. 2;

FIG. 3a is a representation of a twin-walled composite sheet according to the present invention having a corrugated external profile;

FIG. 3b is a representation of a twin-walled composite sheet according to the present invention having a trapezoidal external profile;

FIG. 4 is a sectional view of a twin-walled composite sheet according to the present invention in which the inner film has terraced kinks; and

FIG. 5 is a sectional representation of a twin-walled sheet according to the present invention.

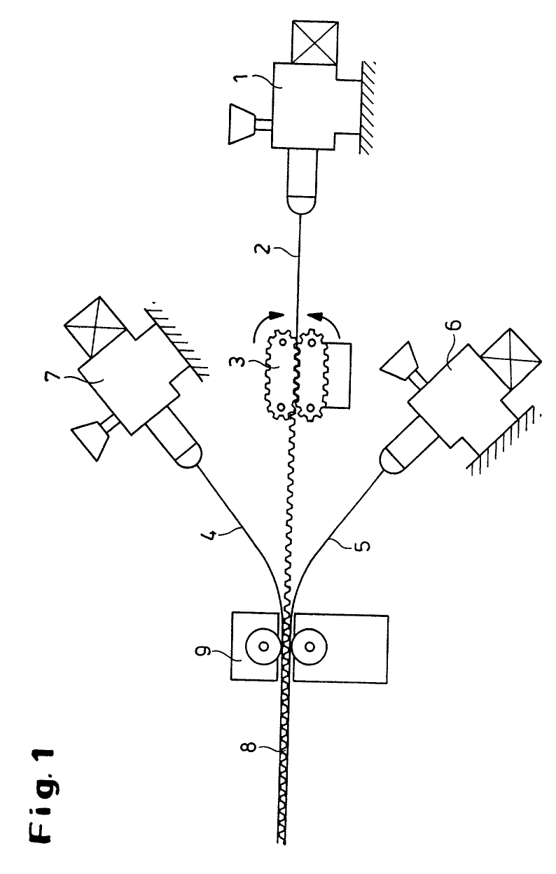

In FIGS. 1-5, like reference numerals designate the same components and structural features.

### DETAILED DESCRIPTION OF THE INVENTION

The twin-wall composite sheets of the present invention preferably have substantially the same flexural strength in both main directions of extension relative to said inner film, if the inner and outer films are prepared from isotropic thermoplastics. As used herein and in the claims, the term “both (or two) main directions of extension” means: (i) the direction that is parallel to the direction of extrusion of the film; and (ii) the direction that is perpendicular to the direction of extrusion of the film.

When using fiber-reinforced thermoplastics, in particular for the outer layers, the composite sheets exhibit a flexural strength which is not quite identical in the extrusion direction and perpendicular thereto, according to the anisotropy of the materials used.

In a right-angled film, the main direction of extension should be taken to mean the directions predetermined by the edges.

Suitable thermoplastics from which the inner film may be fabricated include, but are not limited to are: polycarbonate (PC); PC-acrylonitrile-butadiene-styrene (ABS) mixtures; ABS; polyacrylates, for example poly(methylmethacrylate) (PMMA); styrene-acrylonitrile (SAN); TS; polyalkylenes, e.g., polypropylene (PP); and polyesters, e.g., poly(butanolterephthalate) (PBT). The thickness of the inner film is preferably 0.05 to 2 mm, and more preferably 0.2 to 1.0 mm.

The outer films generally each typically have the shape of a flat sheet. However, they can also each independently have a different three-dimensional structure which is not identical to the structure of the inner film.

The secure (or fixed) connection between the inner film and the outer films is preferably brought about by means of thermal forming of the films, rather than by means of an additional adhesive.

The maximum height of the elevations or maximum depth of the depressions of the inner film are each independently and preferably 1 to 300 times, preferably 5 to 100 times, particularly preferably 5 to 50 times the film thickness of the inner film.

In a preferred embodiment of the present invention, the inner film and the outer films each consist of the same thermoplastic polymer material, in particular transparent thermoplastic polymers, preferably thermoplastic polycarbonate or mixtures thereof with other polymers, such as ABS.

In another preferred embodiment, the inner film and the outer films each consist of different thermoplastic polymer materials.

Thermoplastic polymers from which the outer films of the twin-walled sheet of the present invention may be fabricated include those thermoplastic polymers recited previously herein with regard to the inner film. In a preferred embodiment, the thermoplastic polymers of the outer films are fiber-reinforced thermoplastic polymers, e.g., thermoplastic polymers reinforced with glass fibers. The thickness of the outer films is preferably 0.1 to 3 mm, particularly preferably 0.2 to 2 mm.

In a particularly preferred embodiment of the present invention, the elevations and/or depressions of the inner film have pre-formed kinks. As used herein and in the claims, the term “kinks” means folds within the elevations and/or depressions of the inner film that allow the inner film to be reversibly compressed or expanded. As the inner film is interposed between and fixedly attached to at least two outer films, the kinks within the inner film allow for the whole twin-walled composite sheet of the present invention to be reversibly compressed or expanded, preferably in a direction that is substantially perpendicular to the surface of the outer films. The kinks within the inner film are described in further detail herein with reference to FIG. 4.

The kinks within the inner film may be formed by positive or negative vacuum thermoforming or mechanical forming of the inner film. The thermoplastic polymers recited previously herein with regard to the inner film may be used when kinks are introduced therein. Partially crystalline thermoplastic polymers are however preferred when kinks are introduced into the inner film. Examples of partially crystalline thermoplastic polymers from which the inner film may be fabricated include, but are not limited to, thermoplastic polyamides (PA), thermoplastic poly(butanol-terephthalate) (PBT), and thermoplastic polypropylene (PP). Such partially crystalline thermoplastic polymers are particularly suitable for frequent reversible actuation (flip-flop effect).

The kinks can allow for a preferred shaping perpendicular to the surface of the twin-wall composite sheet. The total thickness of the twin-wall composite sheet can thus be reversibly adjusted, e.g., by means of applying pressure in a direction substantially perpendicular to the surface of one or both of the outer films. An example of an application in which a twin-wall composite sheet according to the present invention which includes kinks in the inner film may be used, is as a polyurethane roof liner in a motor vehicle.

The twin-wall composite sheets according to the invention can be produced by a method in which an inner film made of thermoplastic polymer is provided with a three-dimensional structure which comprises a plurality of elevations and depressions, in particular periodically recurring elevations and depressions along the two main directions of extension, and the inner film is brought into contact with at least one external film at one side of the inner film respectively and the films are securely connected to one another. This is typically done by using the inherent heat of the three layers during the production process. As used herein and in the claims with regard to the inner and outer films of the twin-wall composite sheet, the term “inherent heat” means the residual heat present within the films as a result of the extrusion formation of each film.

The inner film is preferably provided with the three-dimensional structure by means of positive or negative thermoforming or embossing.

Suitable embossing or thermoforming devices and suitable operating conditions are known to the person skilled in the art and are described in, for example, “Einführung in die Kunststoffverarbeitung” (Introduction to plastics processing) published by Carl-Hanser, Munich, 2^{nd} Edition, 1986, by Professor Georg Menges.

The inner film is preferably connected to the outer films by hot pressing. An adhesion promoter or adhesive is typically used if the thermoplastic polymer materials of the inner and outer films are dissimilar. Suitable devices and methods for additional hot forming and suitable operating conditions are known to those persons skilled in the art, and are described in “Kunststoff Maschinen Führer” (Operators of plastics machines) published by Carl-Hanser, Munich 1992, page 619 ff.

The present invention also relates to a method for producing a twin-wall composite sheet having an external profile. The external profile of the twin-wall composite sheet may be selected from, for example, corrugated external profiles or trapezoidal external profiles. The twin-wall composite sheet is shaped in a shaping device to form a corrugated or trapezoidal external profile immediately after production of the twin-wall composite sheet. The external profile may be introduced into the twin-wall composite sheet while each of the inner and outer films still possess inherent heat resulting from their respective production (e.g., from their respective extrusion formation).

It is also possible to provide the twin-wall composite sheet with an external profile in a different manner, in which the inner pre-shaped film is guided, together with the outer films, in the cold state into a corrugating embossing device in which the contact faces of the films are welded to one another by the application of heat, and at the same time the external corrugated or trapezoidal profile is embossed, fixed and/or introduced into the composite sheet. External profiles introduced in such a manner typically result in a lower inherent tension between the films of the twin-wall composite sheet.

### EXAMPLES

### Example 1

FIG. 1 is a schematic representation of a process by which twin-wall composite sheets according to the present invention may be formed.

An inner film (2) made of thermoplastic polycarbonate (PC) with a width of up to about 2.10 m and a film thickness of 0.5 mm was conveyed from the extruder (1) at a rate of about 10 to 100 kg/h. The inner film (2) was conveyed through an embossing device (3) in which the inner film (2) was formed into a regular three-dimensional structure. The two outer films (4) and (5) each having a width of up to about 2.10 m and a film thickness of 0.5 mm were conveyed at a rate of about 10 to 100 kg/h from two further extruders (7) and (6) respectively. The outer film (4) was brought into contact with the inner film (2) from above, the outer film (5) from below. The films (5), (2) and (4) located one on top of the other were conveyed together through a connecting station (9) which securely connected (or fixedly attached) the outer films (4) and (5) to the inner film (2) at the softening temperature of the PC (i.e., above 180° C.) for a dwell time of a few seconds to form the twin-wall composite sheet (8).

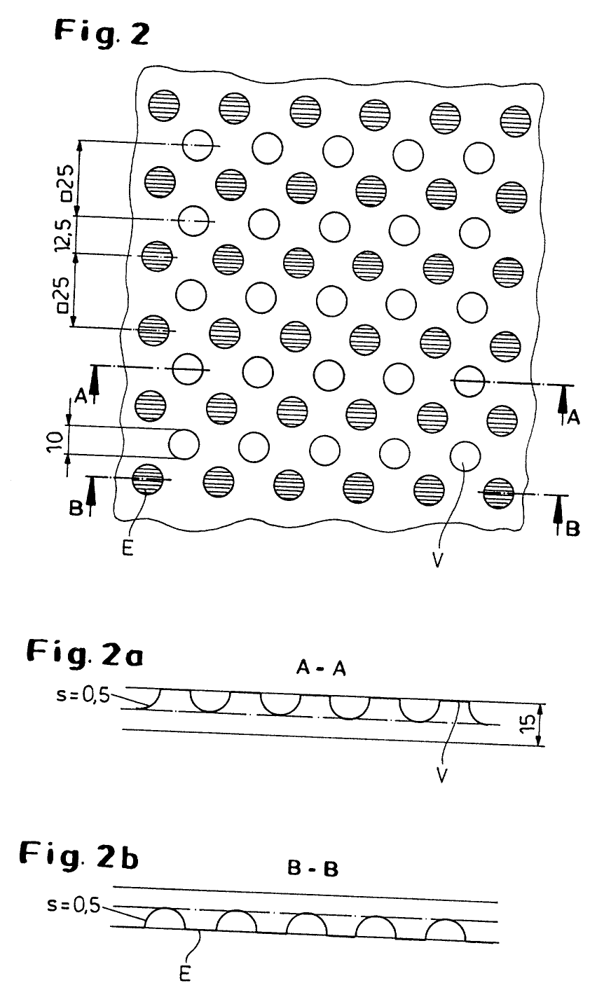

In the composite sheet (8), the distance between adjacent elevations or recesses in the inner film (2) is 25 mm. With reference to FIG. 2, the elevations E or recesses V are connected to the outer films (4) and (5) over an area 10 mm in diameter. The twin-wall composite sheet (8) has an overall height of 16 mm. The recesses/elevations are uniformly spaced apart in FIG. 2. FIGS. 2a and b show cross-sections through the inner film (2) prior to connection with the outer films.

### Example 2

With reference to FIG. 4, in a variation of Example 1, elevations E with terraced kinks (10) are applied to the inner film instead of the hemispherical elevations E or recesses V. A sectional representation through the resultant composite A having two outer films is shown on the right-hand side of FIG. 4.

The left-hand side of FIG. 4 shows the maximum possible shaping (or compression) of a twin-wall composite sheet of this type. Twin-wall composite sheet B on the left-hand side of FIG. 4 is the same as that of composite sheet A which has been compressed in a direction perpendicular to the surface of outer films 4 and 5.

### Example 3

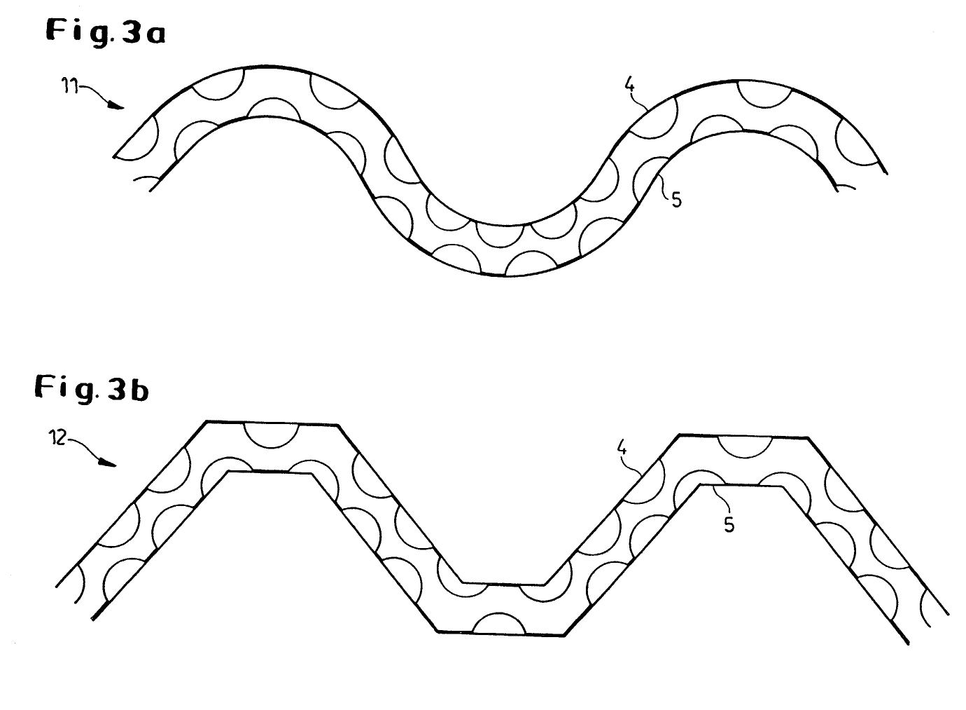

With reference to FIG. 3a, a twin-wall composite sheet (8) produced according to Example 1, was subjected to three-dimensional shaping to form a twin-wall composite sheet (11) having a corrugated external profile, immediately after connection of the inner film (2) to the outer films (4) and (5) by means of a corrugated rolling profile tool (not shown). With reference to FIG. 3b, a twin-wall composite sheet (8) was similarly processed to form a twin-wall composite sheet (12) having a trapezoidal external profile by means of a trapezoidal rolling profile tool (not shown).

Comparison

A 16 mm composite twin-wall sheet made of polycarbonate with a wall spacing of 25 mm, which was produced by profile extrusion, served as a comparison.

Result:

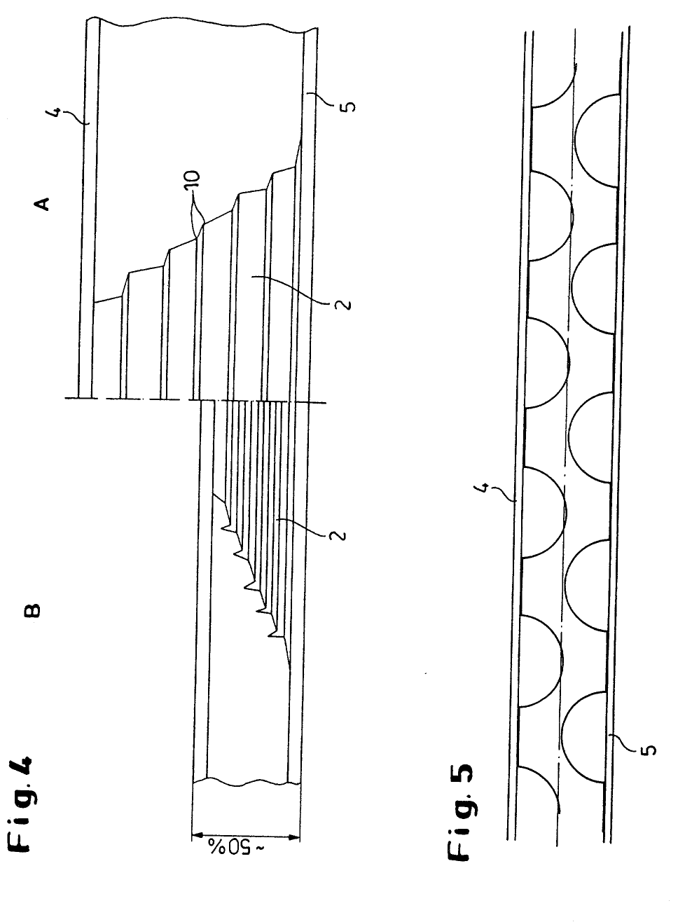

The sheets according to the invention produced in Example 1 (and as represented sectionally in FIG. 5) are 40% lighter than the comparison wall sheet and they withstand forces 2.2 times higher with less deformation. The comparisons were made by two-point flexural tests with a central point load on 16 mm twin-wall and composite sheets according to FIG. 2.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A twin-wall composite sheet comprising:
(a) at least one inner film of a thermoplastic polymer; and
(b) at least two outer films of a thermoplastic polymer, said inner film being interposed between and connected to at least two of said outer films,
wherein said inner film has a three-dimensional structure comprising a plurality of at least one of elevations and depressions, said inner film having two main directions of extension, the three-dimensional structure of said inner film has a substantially periodically recurring pattern in the two main directions of extension of said inner film, and said inner film is fixedly connected to at least two of said outer films in at least one of a region of maximum height of elevations of said inner film and a region of the maximum depth of depressions of said inner film.

2. The twin-walled composite sheet of claim 1 wherein said sheet has substantially the same flexural modulus in the two main directions of extension of said inner film.

3. The twin-wall composite sheet of claim 1 wherein at least one of the maximum height of the elevations and the maximum depth of the depressions of said inner film is 1 to 300 times the film thickness of said inner film.

4. The twin-wall composite sheet of claim 1 wherein the thermoplastic polymer of each of said inner and outer films is the same.

5. The twin-wall composite sheet of claim 4 wherein the thermoplastic polymer of each of said inner and outer films comprises thermoplastic polycarbonate.

6. The twin-wall composite sheet of claim 1 wherein the thermoplastic polymer of said inner film and said outer films are different.

7. The twin-wall composite sheet of claim 1 wherein at least one of the elevations and depressions of said inner film have pre-formed kinks.

8. The twin-wall composite sheet of claim 1 wherein the thickness of said inner film is 0.05 to 2 mm, and each outer film independently has a thickness of 0.1 to 3 mm.

9. The twin-wall composite sheet of claim 1 further having an external profile.

10. The twin-wall composite sheet of claim 9 wherein said external profile is selected from a corrugated external profile and a trapezoidal external profile.

11. A method for producing the twin-wall composite sheet of claim 1 comprising:
(i) providing said inner film with said three dimensional structure comprising a plurality of at least one of elevations and depressions; and
(ii) attaching fixedly at least two of said outer films to said inner film.

12. The method of claim 11 wherein said inner film is provided with said three-dimensional structure in step (i) by one of thermoforming and embossing.

13. The method of claim 11 wherein in step (ii) said inner film is fixedly attached to each outer film by hot forming.

14. The method of claim 11 wherein the thermoplastic polymer of each of said inner and outer films is the same.

15. The twin-wall composite sheet of claim 14 wherein the thermoplastic polymer of each of said inner and outer films comprises thermoplastic polycarbonate.

16. The method of claim 11 wherein the thermoplastic polymer of said inner film and said outer films are different.

17. The method of claim 11 wherein at least one of the elevations and depressions of said inner film are provided with kinks during step (i).

18. The method of claim 11 further comprising the step of (iii) providing said twin-wall composite sheet with an external profile selected from one of corrugated external profiles and trapezoidal external profiles.

19. The method of claim 18 wherein step (iii) is performed while each of said inner and outer films possess inherent heat resulting from their formation.

20. The method of claim 11 wherein said twin-wall composite sheet has substantially the same flexural modulus in the two main directions of extension of said inner film.
